(19) United States
(12) Patent Application Publication
(10) Pub. No.: US 2014/0059582 A1
(43) Pub. Date: Feb. 27, 2014

(54) PARTICIPATION SYSTEM AND METHOD

(71) Applicants: Anthony Michael Knowles, Liphook (GB); Nick Dyer, Guildford (GB); Mark Knowles, Milford (GB)

(72) Inventors: Anthony Michael Knowles, Liphook (GB); Nick Dyer, Guildford (GB); Mark Knowles, Milford (GB)

(21) Appl. No.: 14/001,688

(22) PCT Filed: Feb. 28, 2012
(86) PCT No.: PCT/GB2012/050444

§ 371 Date: Nov. 1, 2013

(30) Foreign Application Priority Data
Feb. 28, 2011 (GB) 1103435.2

(51) Int. Cl. H04H 60/33

(52) U.S. Cl. CPC H04H 60/33
USPC 725/24

(57) ABSTRACT

A computer implemented method of operating an administrator device to facilitate the participation of participants in an event comprises receiving passages of free text from response devices operated by participants; automatically aggregating and displaying the received passages of free text in a free text input region of a display of the administrator device; receiving a user selection of a said passage of free text and copying that selected passage of free text to a response prompt region of said display; generating an output to display the free text in the response prompt region to said participants; receiving a user input via a first clickable icon displayed on said display and, in response, accepting responses from response devices; receiving a user input via said first or a further clickable icon displayed on said display and in response stopping acceptance of further responses from response devices; and automatically aggregating and displaying the accepted responses in a result region of said display and storing into a memory said free text in the response prompt region in association with the aggregated accepted responses.

### FIELD OF THE INVENTION

The present invention generally relates to a method and system for facilitating the participation of participants in a meeting or event.

### BACKGROUND OF THE INVENTION

Meetings are potentially one of the most important aspects of business. Well run meetings are valuable. Badly run meetings are costly to business.

Technology can assist with meetings by providing an infrastructure for communicating and gathering information. Traditionally, meetings are often based around a presentation using software such a Microsoft® PowerPoint®. Such presentation software can be used as a basis for gathering participant's feedback and encouraging their involvement. However, it is restrictive in that it requires the information to be used in the meeting to be pre-prepared and structured. Hence obtaining responses from participants, using for example voting, is restricted to the information and structure of the pre-prepared presentation.

It is an object of one aspect of the present invention to provide an improved participation system and method.

### SUMMARY OF THE INVENTION

According to a first aspect, there is provided a computer implemented method of operating an administrator device to facilitate the participation of participants in an event. The method comprises receiving passages of free text from response devices operated by participants. The received passages of free text are automatically aggregated and displayed in a free text input region of a display of the administrator device. The method further comprises receiving a user selection of a said passage of free text and copying that selected passage of free text to a response prompt region of the display. An output is generated to display the free text in the response prompt region to said participants. A user input is received via a first clickable icon displayed on the display and, in response, responses are accepted from response devices. A user input is received via the first or a further clickable icon displayed on the display and in response acceptance of further responses from response devices is stopped. The accepted responses are automatically aggregated and the accepted responses are displayed in a result region of the display and stored into a memory said free text in the response prompt region in association with the aggregated accepted responses.

In an optional embodiment, the step of generating an output to display the free text includes displaying the free text on one or both of displays of response devices and one or more displays visible to the participants.

In an alternative optional embodiment, the method comprises displaying selectable vote options on the display, the responses comprising selections of the vote options.

As a further option, the received passages of free text are associated in the administrator device with the identities of the respective participants from which the passages of text originated. The step of aggregating and displaying the received passages includes performing an automated analysis on the passages of text to identify passages having similar content as duplicates, and merging duplicates to retain the identities of the participants from which the merged passages of text originated.

As an option, the method includes identifying at least one response device based on content of the passages of free text, and enabling audio or video input from the at least one response device. As a further option, the enabling comprising generating control signals to activate a microphone and/or video capture device at each response device and/or an audio and/or video channel from the at least one response device. The passages of free text from the response devices optionally include identification information uniquely identifying each respective response device, and the identifying comprises receiving a user selection of at least one passage of free text and the identification of the at least one response device using the identification information.

As an option, the method includes recording the passages of free text, selected passages of free text copied to the response region, and responses as meeting information with respect to time, and retrieving the meeting information to enable the searching and playback of the meeting information with respect to time. As a further option, the passages of free text and the responses received from the response devices include information identifying the respective participants. The method optionally includes receiving audio or video inputs from response devices, wherein the recording records the received audio or video with respect to time, and the retrieving enables the searching, retrieval, and playback of audio or video with the meeting information with respect to time. Audio or video received from the response devices may include information identifying the respective participants.

As an option, the method comprises receiving the passages of free text and the responses from response devices via a radio interface of the administrator device.

According to a second aspect, there is provided a computer implemented system for facilitating the participation of participants in an event. The system comprises a display, text receiving means for receiving passages of free text from response devices operated by participants, a first display means for automatically aggregating and displaying the received passages of free text in a free text input region of said display, a first graphical user interface for receiving a user selection of a said passage of free text and copying that selected passage of free text to a response prompt region of said display, generating means for generating an output to display the free text in the response prompt region to said participants. A second graphical user interface is provided for receiving a user input via a first clickable icon displayed on said display and, in response, for accepting responses from response devices, and for receiving a user input via said first or a further clickable icon displayed on said display and in response for stopping acceptance of further responses from response devices. A second display means is provided for automatically aggregating and displaying the accepted responses in a result region of said display.

As an option, the computer implemented system comprises a radio interface for receiving the passages of free text and the responses from response devices.

According to a third aspect, there is provided a computer implemented method of operating an administrator device to facilitate the participation of participants in an event. The method comprises receiving passages of free text from response devices operated by participants. The received passages of free text are automatically aggregated and displayed in a free text input region of a display of the administrator device. The method further comprises receiving a user instruction to select and copy a passage of free text received from a response device, to an audio input region of the display. Audio input is enabled from the response device associated with the passage of free text copied to the audio input region upon receipt of a user input via a clickable icon displayed on the display, wherein the passages of free text are associated with respective response device addresses.

As an option, the enabling comprises generating control signals to activate a microphone at the response device and/or an audio channel from the response device.

According to a fourth aspect, there is provided a computer implemented system for facilitating the participation of participants in an event. The system comprises a display, means for receiving passages of free text from response devices operated by participants, means for automatically aggregating and displaying the received passages of free text in a free text input region of said display, means for receiving a user instruction to select and copy a passage of free text received from a response device to an audio input region of said display, and means for enabling audio input from said response device associated with the passage of free text copied to the audio input region upon receipt of a user input via a clickable icon displayed on the display, wherein the passages of free text are associated with respective response device addresses.

One aspect of the present invention provides a computer implemented method of facilitating the participation of participants in an event, the method comprising receiving passages of free (unstructured) text from response devices operated by participants; displaying the received passages of free text; receiving a selection of a said passage of free text to be used as a basis to for a structured response prompt to elucidate structured responses from participants; generating an output to display the structured response prompt to said participants; receiving structured responses from response devices operated by participants in response to displayed structured response prompt; aggregating structured responses into categories; and displaying the received structured responses by category.

This aspect of the present invention facilitates the free form of a meeting since it enables each participant to input unstructured text which can form an agenda for discussion. The text can be used by an administrator to form structured response options such as vote options. Hence participant inputs can used as prompt for voting.

In one embodiment the structured response prompt comprises a vote prompt with selectable vote options, and the structured responses comprise selections of the vote options.

In one embodiment the selection is made by electronically copying said passage of free text to be used in the generation of said output.

In one embodiment the received passages of free text and the received structures responses are displayed to an administrator, the method including receiving a selection of at least one passage of free text and/or at least one structured response from the administrator, and displaying the selection to the participants.

In one embodiment the method includes transmitting the passages of text to the response devices; at each response device, displaying the passages of free text, receiving inputs from a respective participant to sort or rank the passages of free text, and transmitting data identifying the sorting or ranking of the passages of text; receiving the transmitted data from the response devices, processing the data to determine an overall sort order or ranking, and outputting for display to the participants the overall sort order or ranking of the passages of free text.

In one embodiment, the passages of text are displayed on a participants display or transmitted in near real time (as soon as they are received or soon thereafter) to the response devices to enable the participants to review the input text and either select to agree with the input e.g. vote for it or second it, or to add comments. The ‘real time’ display of the inputs reduces duplicate inputs since participants can select previous input text if they were also going to input text on the same point. This also allows a type of real time vote on the relevance of a topic of the text since participants can vote or second the text i.e. mark it so as to indicate that they agree with it. In one embodiment, the transmission and display of the text provides a useful way of allowing a participant to more easily interact with the text than trying to interact with a common display.

In one embodiment the passages of text identify the respective participants from which the passages off text originated; the method including performing an automated analysis on the passages of text to identify passages having similar content as duplicates; and merging duplicates to retain the identities of the participants from which the merged passages of text originated.

In one embodiment the method includes identifying at least one said response device based on content of said passages of free text; and enabling audio or video input from the at least one response device.

In one embodiment the enabling comprising generating control signals to activate a microphone or video capture device at each response device and/or an audio or video channel from the at least one response device.

In one embodiment the passages of free text from the response devices include identification information uniquely identifying each respective response device, and the identifying comprises receiving a user selection of at least one passage of free text and the identification of the at least one response device using the identification information.

In one embodiment the method includes recording the passages of text and structured responses as meeting information with respect to time; and retrieving the meeting information to enable the searching and playback of the meeting information with respect to time.

In one embodiment the passages of free text and the structured responses received from the response devices include information identifying the respective participants.

In one embodiment the method includes receiving audio or video inputs from response devices, wherein the recording records the received audio or video with respect to time, and the retrieving enables the searching, retrieval, and playback of audio or video with the meeting information with respect to time.

In one embodiment audio or audio received from the response devices includes information identifying the respective participants.

Another aspect of the present invention provides a computer implemented system for facilitating the participation of participants in an event, the system comprising text receiving means for receiving passages of free text from response devices operated by participants; display means for displaying the received passages of free text; selection means for receiving a selection of a said passage of free text to be used as a basis for a structured response prompt to elucidate structured responses from participants; generating means for generating an output to display the structured response prompt to said participants; response receiving structured responses from response devices operated by participants in response to displayed structured response prompt; and aggregating means for aggregating structured responses into categories; wherein said display means is adapted to display the received structured responses by category.

Another aspect of the present invention provides a participant response method comprising receiving passages of free text at a response administration device from response devices operated by participants, and transmitting the passages of text to the response devices; at each response device, displaying the passages of free text, receiving inputs from a respective participant to sort or rank the passages of free text, and transmitting data identifying the sorting or ranking of the passages of text to the response administration device; at the response administration device, receiving the transmitted data from the response devices, processing the data to determine an overall sort order or ranking, and outputting for display to the participants the overall sort order or ranking of the passages of free text.

Another aspect of the present invention provides a participant response system comprising a response administration device comprising means for receiving passages of free text at from response devices operated by participants, and transmitting the passages of text to the response devices; and response devices, each response device comprising means for displaying the passages of free text, means for receiving inputs from a respective participant to sort or rank the passages of free text, and means for transmitting data identifying the sorting or ranking of the passages of text to the response administration device; the response administration device further comprising means for receiving the transmitted data from the response devices, means for processing the data to determine an overall sort order or ranking, and means for outputting for display to the participants the overall sort order or ranking of the passages of free text.

This aspect of the invention enables participants to not only provide input to drive the direction of a meeting, but also to see the input from other participants and to provide further input by sorting or ranking the text passages to indicate what is most important to each participant. This sorting or ranking is a form of voting. The administrator's computer will process the results to weight the text passages according to the sort/rank data so as to determine what is most important to the participants. This assists in directing and focusing the meeting.

Another aspect of the present invention provides a participant response method comprising receiving text at a response administration device from response devices operated by participants, the text identifying the respective participants from which the text originated; performing an automated analysis on the text to identify text having similar content as duplicates; and merging duplicates to retain the identities of the participants from which the merged text originated.

Another aspect of the present invention provides a participant response system comprising means for receiving text at a response administration device from response devices operated by participants, the text identifying the respective participants from which the text originated; means for performing an automated analysis on the text to identify text having similar content as duplicates; and means for merging duplicates to retain the identities of the participants from which the merged text originated.

This aspect of the invention reduces redundant information by removing duplicate responses from participants. This technique can be applied to unstructured text responses and to structured text responses (votes). The structures text responses are more constrained because they are options from a limited range of responses possible to a question posed (a vote).

Another aspect of the present invention provides a voting system comprising a plurality of voting handsets for the input of votes by voters, each handset including a visual vote indicator to provide a visual indication of the vote input by the voter; and a voting administration device for receiving votes input by votes using the handsets.

Another aspect of the present invention provides a voting method comprising providing a visual indication of a vote input by a voter at each of a plurality of voting handsets; and receiving votes input by votes using the handsets.

This aspect of the present invention enables response devices to be used which do not identify the participant while still allowing an administrator or meeting manager to identify participants who voted in a particular way so that they can ask that participant if they wish to speak, for example to explain why they voted for their option.

Another aspect of the present invention provides a participant response method comprising receiving responses from response devices operated by participants; identifying at least one said response device based on content of said received responses; and enabling audio or video input from the at least one response device.

This aspect of the present invention enables an administrator to select to allow a participant to speak in a meeting based on the content of their response. For example, the participant may have raised an interesting point in a free text input which diverges from other free text inputs by other participants and the administrator is interested to hear why the participant thinks this issue is important.

In one embodiment the enabling comprising generating control signals to activate a microphone or video capture device at each response device and/or an audio or video channel from the at least one response device.

In one embodiment the responses comprise votes and/or free text.

In one embodiment the responses from the response devices include identification information uniquely identifying each respective response device, and the identifying comprises receiving a user selection of at least one response and the identification of the at least one response device using the identification information.

Another aspect of the present invention provides a participant response system comprising means for receiving responses from response devices operated by participants; means for identifying at least one said response device based on content of said received responses; and means for enabling audio or video input from the at least one response device.

Another aspect of the present invention provides a participant response system for use in capturing information content of a meeting, the system comprising response input means for receiving responses from response devices operated by participants during a meeting, the responses comprising free text responses and votes; output means for outputting a display of information to the participants, the information including voting prompts; recording means for recording the responses and information as meeting information with respect to time; and meeting information retrieval means for retrieving the meeting information to enable the searching and playback of the meeting information with respect to time.

This aspect of the present invention provides for the time based capture of information on a meeting. The capture of the responses from participants and any information displayed can be used as a record of the meeting. Responses from participants can be captured on a session by session basis.

In one embodiment, each session comprises a topic or agenda which can be selected as being one of the free text responses given in a previous session. In this way sessions can be captured in a hierarchical manner with each session linked back to a topic (text) in a previous session.

In one embodiment the responses received from the response devices include information identifying the respective participants.

In one embodiment the system includes audio input means for receiving audio or video inputs from response devices, wherein the recording means is adapted to record the received audio or video with respect to time, and the meeting information retrieval means is adapted to search, retrieve, and playback audio or video with the meeting information with respect to time.

In one embodiment audio or video received from the response devices includes information identifying the respective participants.

Another aspect of the present invention provides a participant response method for capturing information content of a meeting, the method comprising receiving responses from response devices operated by participants during a meeting, the responses comprising free text responses and votes; outputting a display of information to the participants, the information including voting prompts; recording the responses and information as meeting information with respect to time; and retrieving the meeting information to enable the searching and playback of the meeting information with respect to time.

Another aspect of the present invention provides a participant response system for use in capturing information content of a meeting, the system comprising response input means for receiving responses from response devices operated by participants during a meeting, the responses comprising free text responses and votes; audio or video input means for receiving audio or video inputs from response devices; output means for outputting a display of information to the participants, the information including voting prompts; recording means for recording the responses, information and audio or video as meeting information; and meeting information retrieval means for retrieving the meeting information to enable the searching and playback of the meeting information.

This aspect of the invention provides for the capture of responses, information and audio or video for a meeting. This captured data can be used as electronic “minutes” of a meeting and enable all aspects of the discussions that took place to be recalled.

In one embodiment the responses and audio received from the response devices include information identifying the respective participants.

Another aspect of the present invention provides a participant response method for capturing information content of a meeting, the method comprising receiving responses from response devices operated by participants during a meeting, the responses comprising free text responses and votes; receiving audio or video inputs from response devices; outputting a display of information to the participants, the information including voting prompts; recording the responses, information and audio or video as meeting information; and retrieving the meeting information to enable the searching and playback of the meeting information.

Another aspect of the invention provides a participant response method comprising receiving passages of free text at a response administration device from response devices operated by participants, and transmitting the passages of text to the response devices; at each response device, displaying the passages of free text, receiving inputs from a respective participant, receiving a selection of at least one passage of free text, and transmitting data identifying the passages of text which have been selected to the response administration device; at the response administration device, receiving the transmitted data from the response devices, and processing the data to mark the at least one selected passages identifying the selection.

In one embodiment the method includes transmitting updates to the transmitted passages of text from the response administration device to each response device, and at each response device displaying the updated passages of text to indicate the selections received at said selection devices.

Another aspect of the invention provides a participant response system comprising a response administration device comprising receiving means for receiving passages of free text at from response devices operated by participants, and transmitting menas for transmitting the passages of text to the response devices; and response devices, each response device comprising display means for displaying the passages of free text, means for receiving a selection from a respective participant of at least one passage of free text, and means for transmitting data identifying the passages of text which have been selected to the response administration device; wherein said receiving means of the response administration device is adapted to receive the transmitted data from the response devices, and the response administration device includes means for processing the data to mark the at least one selected passages identifying the selection.

Another aspect of the invention provides a participant response method comprising receiving passages of free text at a response administration device from response devices operated by participants, and transmitting the passages of text to the response devices; at each response device, displaying the passages of free text, receiving inputs from a respective participant to identify passages of free text a participant considers should be merged, and transmitting data identifying the passages of text to be merged to the response administration device; at the response administration device, receiving the transmitted data from the response devices, processing the data to determine an overall merging of the passages of text, and outputting for display to the participants the overall merged passages of free text.

A further aspect of the invention provides a participant response system comprising a response administration device comprising means for receiving passages of free text at from response devices operated by participants, and transmitting the passages of text to the response devices; and response devices, each response device comprising means for displaying the passages of free text, means for receiving inputs from a respective participant to identify passages of free text a participant considers should be merged, and means for transmitting data identifying the passages of text to be merged to the response administration device; the response administration device further comprising means for receiving the transmitted data from the response devices, means for processing the data to determine an overall merging of the passages of text, and means for outputting for display to the participants the overall merged passages of free text.

A further aspect of the present invention provides a participant response method comprising receiving passages of free text at a response administration device from response devices operated by participants, and transmitting the passages of text to the response devices; at each response device, displaying the passages of free text, receiving inputs from a respective participant to add comments to selected passages of free text, and transmitting data identifying the comments to the response administration device; at the response administration device, receiving the transmitted data from the response devices, processing the data, and outputting for display to the participants the passages of free text with added comments.

A further aspect of the present invention provides a participant response system comprising a response administration device comprising means for receiving passages of free text at from response devices operated by participants, and transmitting the passages of text to the response devices; and response devices, each response device comprising means for displaying the passages of free text, means for receiving inputs from a respective participant to add comments to selected passages of free text and means for transmitting data identifying the comments to the response administration device; the response administration device further comprising means for receiving the transmitted data from the response devices, means for processing the data, and means for outputting for display to the participants the passages of free text with added comments.

The present invention can be embodied as computer readable code executed on a computer. Hence the present invention encompasses a carrier medium carrying computer readable code for controlling a computer to carry out the method. The carrier medium can comprise a transient medium such as a signal e.g. an electrical signal, an electromagnetic signal, an optical signal, a magnetic signal, or a signal carrying the code over a network such as the internet (e.g. a TCP/IP signal). The carrier medium can also comprise a storage medium. Such a storage medium can be non-transitory. Examples of such storage media are: a hard disk, a floppy disk, magnetic media, solid state memory, an optical disk etc.

The present invention also encompasses a computer system comprising a data memory storing data; a processor; and a program memory storing computer implementable instructions for controlling a computer to carry out the steps of the methods described above.

### BRIEF DESCRIPTION OF THE DRAWINGS

FIG. 1 is a schematic diagram of a system according to one embodiment of the present invention;

FIG. 2 is a schematic diagram of the functional code provided within the response processor of the embodiment of FIG. 1;

FIG. 3 is a schematic diagram of a response device according to one embodiment of the present invention;

FIG. 4 is a schematic diagram of another embodiment of the present invention;

FIG. 5a to e is a flow diagram illustrating the method of operating a system according to one embodiment of the present invention;

FIG. 6 is a diagram illustrating a display interface on the administrator's display in FIG. 1 in accordance with one embodiment of the present invention.

### DETAILED DESCRIPTION OF EMBODIMENTS OF THE INVENTION

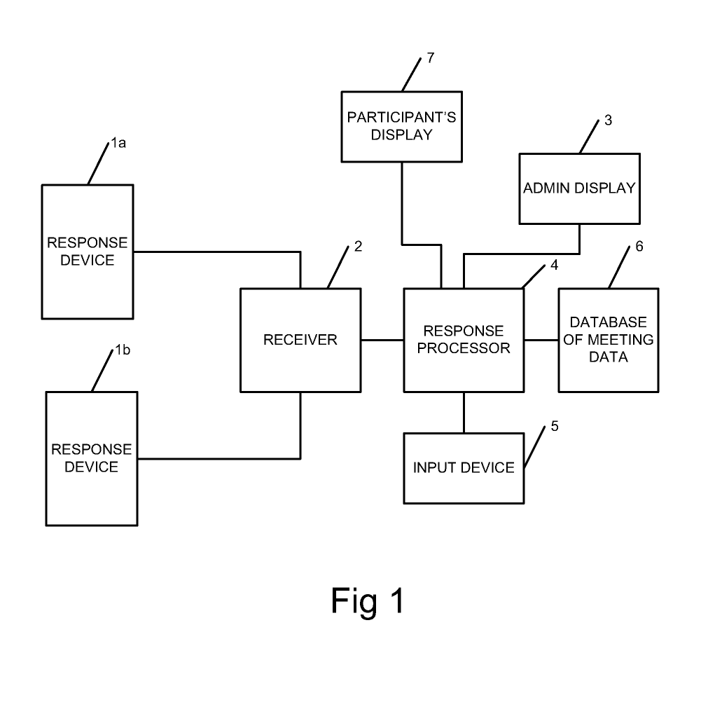

An embodiment of the present invention will now be described with reference to FIGS. 1 to 3.

As shown in FIG. 1, the system comprises a plurality of response devices 1a and 1b for use by participants for entering their response to the options (votes or structured responses) and for entering free text responses as passages of text (unstructured participant responses). The responses are transmitted to a receiver 2. A response processor 4 processes the received responses. Also the response processor 4 generates an output signal to a participant's display 7 to generate a display of a question and the options that a participant can select as a response. Alternatively or in addition the output display signal can be sent to the response devices 1a and 1b when they include a display.

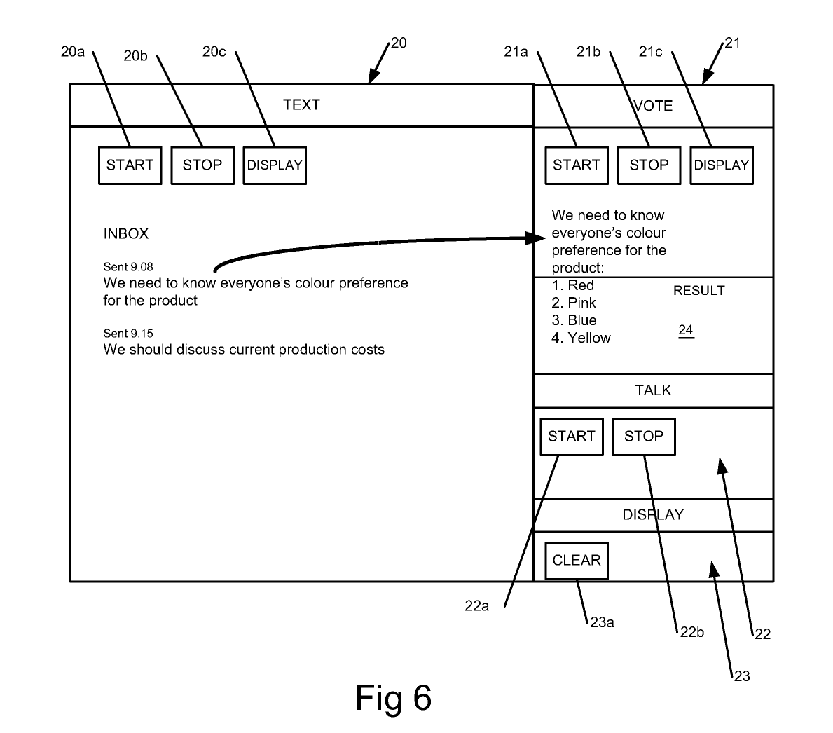

An input device 5 is provided to enable an administrator or manager who is managing or administering the meeting or other participation environment to input questions and options for display and also to make selections of received text for use as voting options or to select the sending participant to speak (as will be discussed in more detail herein after). The input device 5 can also be used by the administrator to make control selections to control aspects of the meeting as will be described in more detail herein after. An administrator display 3 is provided which displays an interface as shown in FIG. 6, which will be described in more detail hereinafter.

A database of response data 6 is provided to store the free text responses, questions, options and responses by the participants. The participants are uniquely identified

In this embodiment, the response devices 1a and 1b can comprise any suitable electronic device enabling a participant to input a response comprising free text (an unstructured response) or a vote (a structured response). The input can be by way of a keypad on the device, by use of a pointing device or by a gesture. The devices can comprise a computer connected by a communications network to the receiver. Such an arrangement can comprise a network of computers using a local area network, a wide area network of the internet. The communication channel can be wired or wireless. Alternatively the devices can be handsets. Such handsets include mobile telephones and smart phones which communicate wirelessly. Alternatively the handsets can be dedicated response devices which can be wired or wireless. The wireless communication can be by way of an electromagnetic signal e.g. a radio frequency signal or an optical signal e.g. an infrared beam. The communication channel used can comprise a network connection and/or a telecommunication connection. For example, free text responses can be submitted by SMS message, email, or in data form using a proprietary communication protocol.

In one embodiment of the invention, the system enables the use of a mix of types of response devices. For example, some participants may be provided with handsets in a meeting room. Some participants may be remote and hence use computers as response devices connected over the internet. Some participants may even be ‘out in the field’ and will hence use their mobile telephones or smart phones as response devices over a telecommunications link providing a data network.

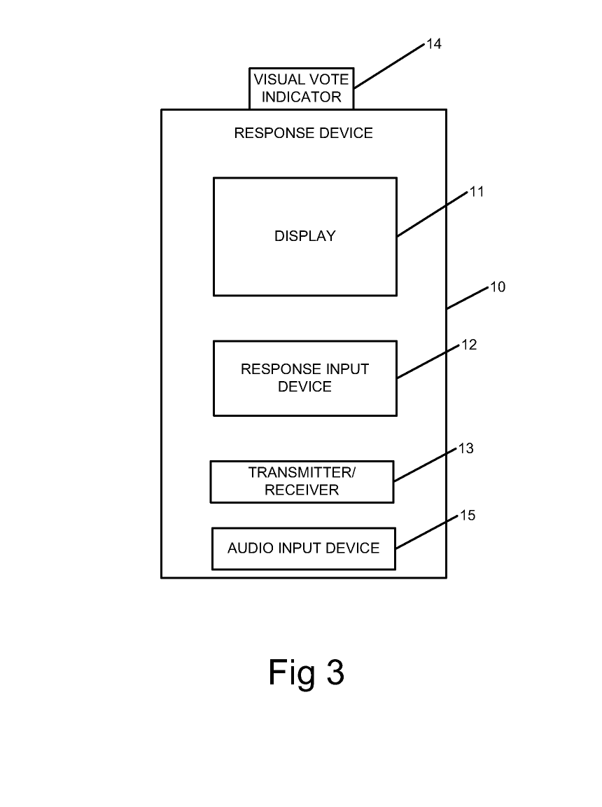

FIG. 3 illustrates schematically a response device 10 according to one embodiment. A display 11 is provides to display the question and options for response by the participant and for displaying free text passages for ranking or sorting or commenting upon. An input device 12 such as a keypad is provided to enable the input of the option selection by the participant, to sort or rank free text lists and to input comments or mark text. A transmitter/receiver 13 is provided to receive display information for display of the texts lists, question and options on the display 11 and for transmitting the participants responses (selected option, sorting/ranking data, or marking data) to the receiver 2.

In FIG. 3 the response device 10 is provided with a display. This enables the text lists, question and options to be displayed to the participants individually and hence by controlling the output display signal to the response devices 10, the display of text lists, questions and options can be confined to certain participants to prevent participants not selected from responding. Also this enables the participant to be located remotely from the response control system comprising the receiver 2, the response processor 4, the input device 5 and the database of response data 6. If all of the participants are remote and the response devices are connected by a communications network, the display 7 is not required.

However, the response devices need not have displays. The display 7 can be provided to be visible by the participants in a location when the participants are in the location e.g. a meeting room.

The response device 10 in this embodiment includes an audio input device 15 such as a microphone to permit the participant to speak and have their audio transmitted by the transmitter 13 to the receiver 2 for broadcast to all participants of the meeting or event.

The response processor 10 also includes a visual vote indicator 14 to provide a visual indicator on the handset of the vote option selected. The indicator 14 can for example comprise coloured LEDs. Such an arrangement provides for limited vote indications. For example, if a vote is taken the selectable options provided for the participant can be option 1, 2, or 3. The indicator can have coloured LEDs corresponding to an option number e.g. red=1, green=2, orange=3. The purpose of the indicator 14 is to enable the use of a system in which the identity of the response device 10 and the participant is not transmitted to the response processor 4 with the vote. This allows anonymous voting. When handsets are used for voting in a meeting area, the visual indicator 14 allows the administrator to identify participants who voted in a particular manner so that they can direct questions to or invite comments from the participants based on the way they voted.

Returning to the system of FIG. 1, the receiver 2, the displays 3 and 7, the response processor 4, the input device 5 and the database of response data 6 can be implemented in a computer system or a single computer.

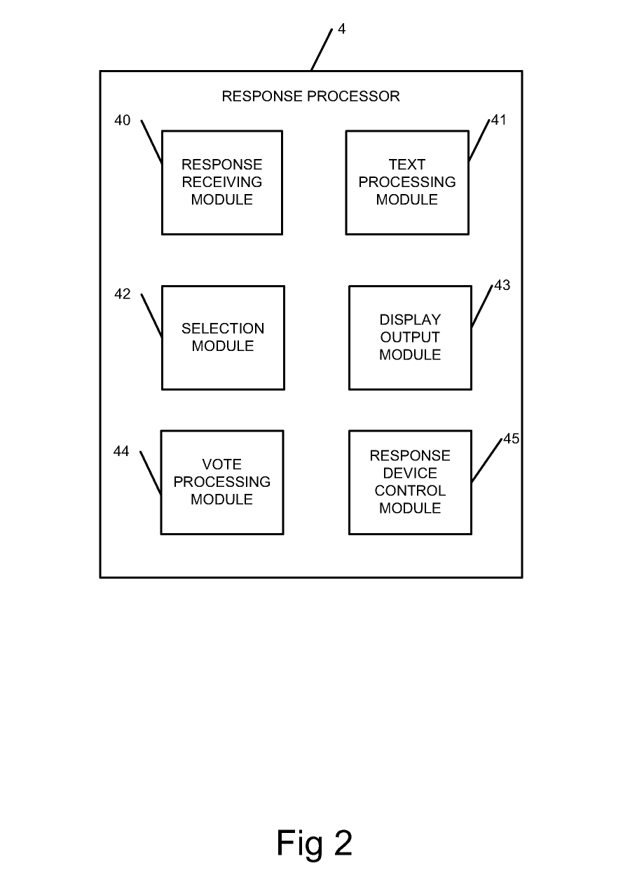

The response processor 4 implements computer program code to provide the functionality. FIG. 2 schematically illustrates the code modules that provide the functionality. A text processing generation module 41 operates to process the input free text from the participants. A participant selection module 42 operates to enable the administrator to make selections of text passages or other selections on the interface of the administrator display 3. A display output module 43 operates to generate an output signal for display on the administrator display 3 and on the participant's display 7 or on the response devices.

A response receiving module 40 operates to receive responses from response devices via the receiver 2 and to store the responses in the database of meeting data 6. The receiver 2 in a computer implementation will comprise a network communications port or adapter. The responses can be indexed by a unique participant identifier or by a unique response device identifier. It can be assumed a participant will not change response devices during a meeting or other response event. At the beginning of the meeting or response event the participant can register their identity for the response device during an initial registration period for example. Hence the database 6 can also store data uniquely associating participants with response devices. The responses received from participant's response devices are stored to be associated with the response (text and votes) and their unique identity (via their identified response devices if necessary).

The response processor 4 can also include a response device control module 45 in an embodiment where it is possible to control response devices to disable the receipt of responses from participant's who are not selected for responding to the next question and options and/or to enable and disable the audio capability of the response device 1a and 1b so that the participant can be allowed and disallowed to speak. This control module can operate over a communications network to disable a response device from accepting an input (text, vote selection, or audio (e.g. disable the microphone)) from a participant, or to disable the transmission of an input (text, vote selection, or audio).

A vote processing module 44 is also provided to process data for providing the voting function. This module operates to process selected text to generate a vote and vote options, and to process the vote responses to provide a processed vote outcome.

Although in this embodiment specific code modules are illustrated, it will be apparent to a skilled person in the art that this is merely one embodiment and the code modules can be combined in any combination or indeed provided as a single block of code.

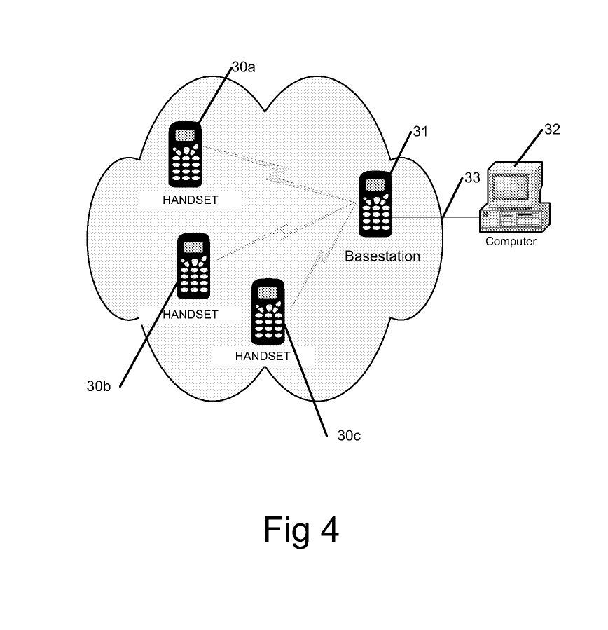

FIG. 4 illustrates an alternative embodiment of the present invention. In this embodiment the response devices comprise handsets 30a, 30b, 30c. These handsets are in wireless communication with a base station 31. In this embodiment the base station 31 is also a handset configured by software to operate as a base station. The base station is connected by a wired link 33 to a computer 32. The computer 32 provides the functionality of the response processor 4, input device 4, display 3 and database 6 of the embodiment of FIG. 1. In this embodiment the handsets are provided with displays and keypads and have the same functionality as the response devices of the first embodiment.

Although in this embodiment a computer 32 is provided to perform the processing, in an alternative embodiment, the handset operating as the base station 31 can be programmed to provide the same functionality as the computer 32 and hence the computer 32 is not required. The questions and options can be input by an administrator using the keypad on the base station 31 and the questions and options can be displayed to participants on their handsets 30a, 30b and 30c. The handsets can for example comprise current smart phone technology which provides similar capabilities to portable computers with limited display space. This provides a ‘peer-to-peer’ type of system where no unique apparatus is required. The participants and the administrator is provided with the same hardware. The functionality is modified by appropriate code operating of the handsets which can be downloaded over the network, initially downloaded from a computer such as computer 32 over a wired connection, or input from a smart card or solid state memory when the handset has a smart card or solid state memory reader.

The system of the present invention can be implemented in a voting or response system such as that described in WO2004/017662, the content of which is hereby incorporated in its entirety by reference.

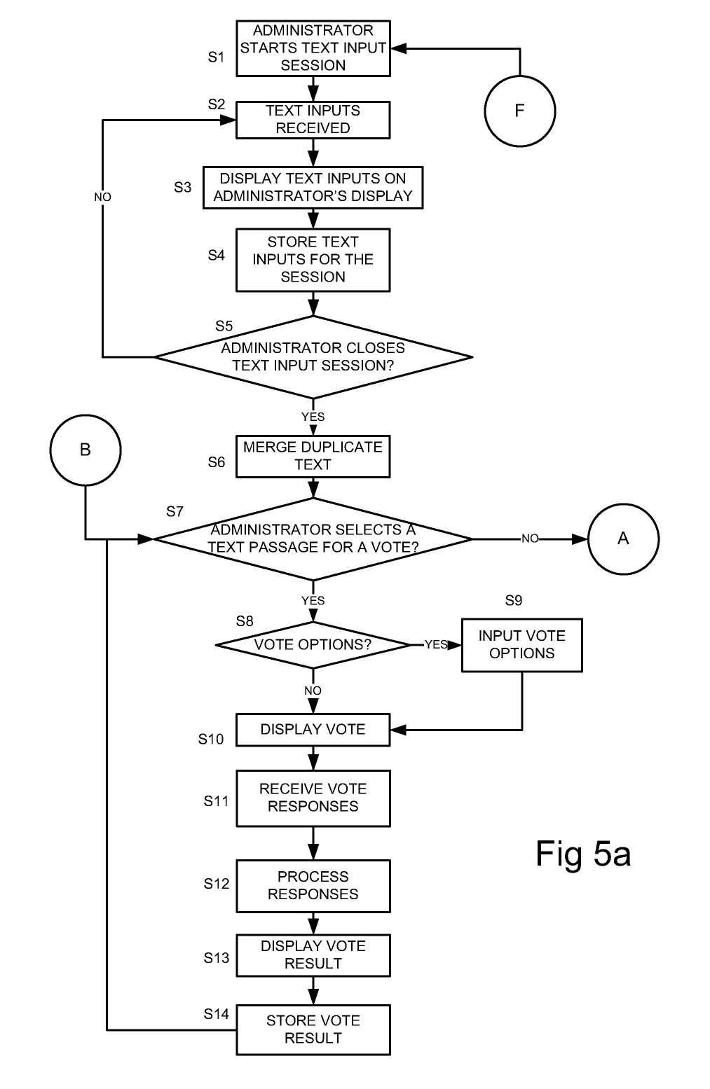

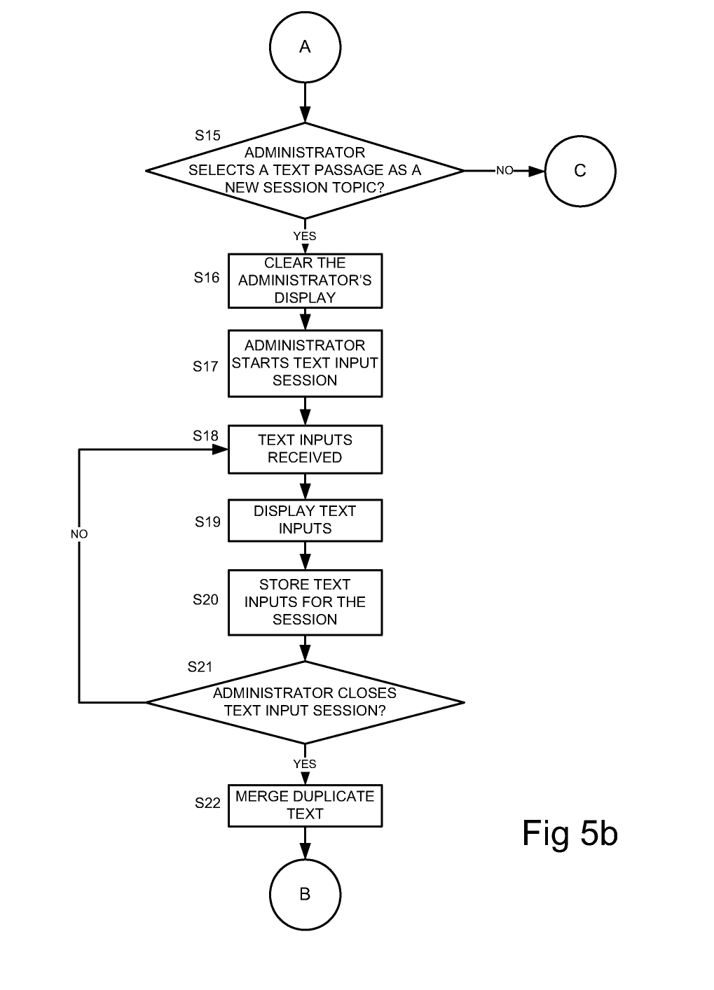

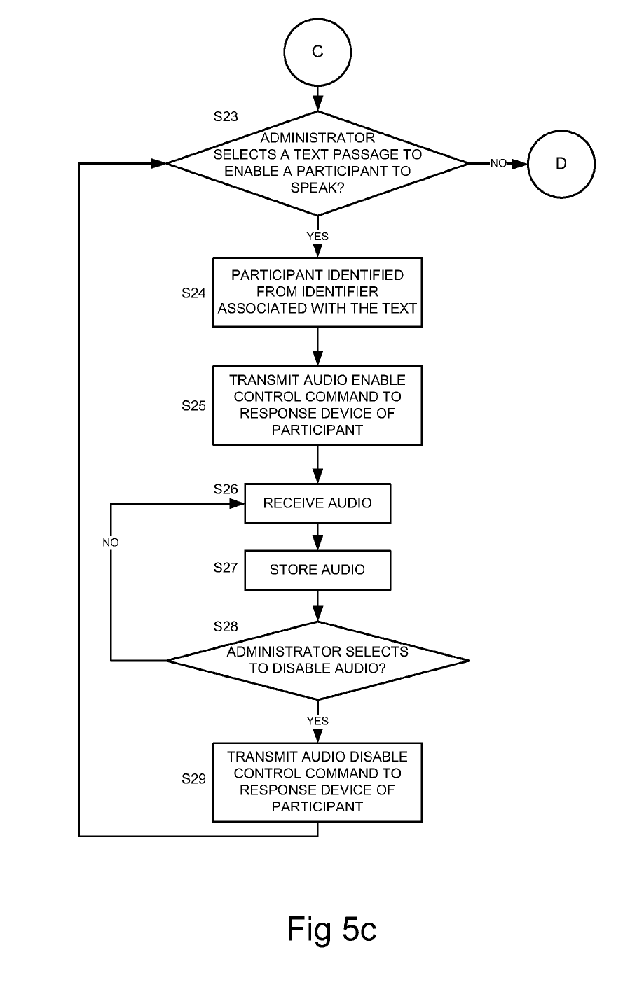

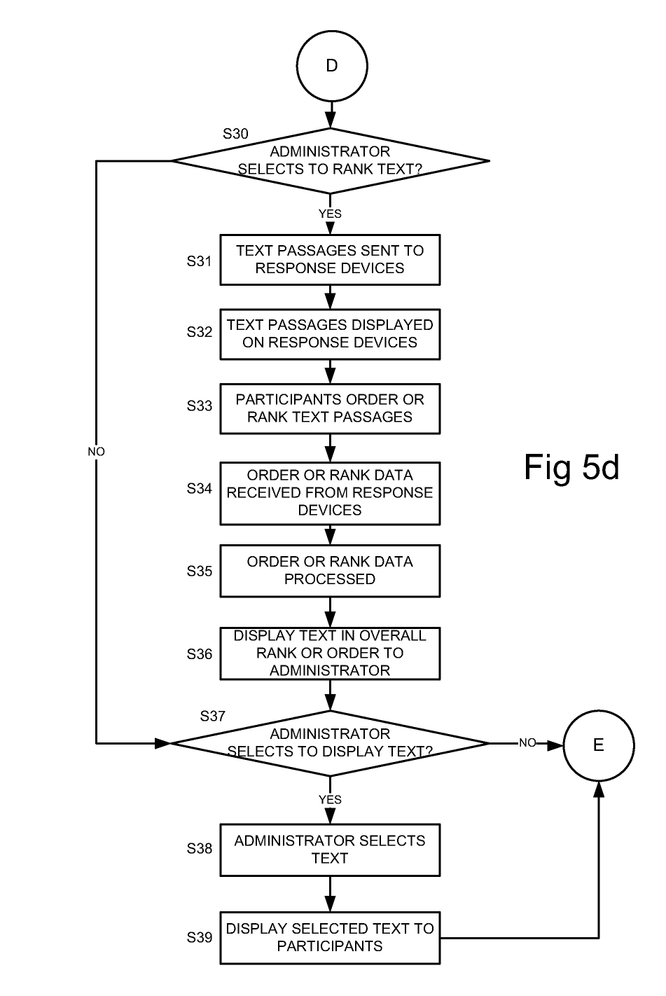

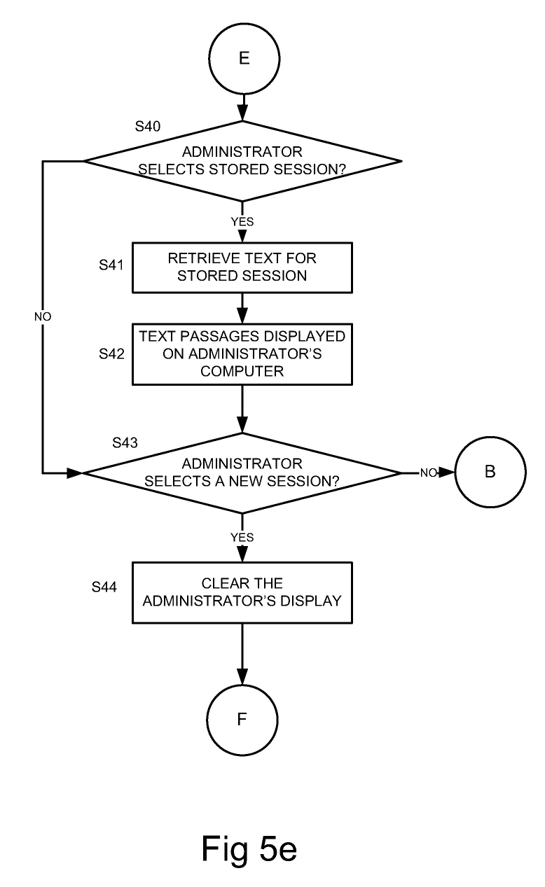

The operation of an embodiment of the present invention will now be described with reference to FIGS. 5a to e and 6.

FIG. 6 illustrates a user interface provided on the administrator display 3. The interface comprises five regions, namely: a free text input region 20, a response prompt region 21, an audio input region 22, a display control region 23 and a result region 24.

The text input region 20 includes control icons 20a, 20b and 20c. The administrator can make the selections of the icons using a pointing device such as a mouse or tracker ball or using a touch screen or gestures. A start icon 20a enables an administrator to start receiving and capturing free text responses from participants. The stop icon 20b enables an administrator to select to stop the capture of free text. The display icon 20c enables the administrator to select to display any of the received free text responses on the participant's display 7 or the displays of the response devices. In FIG. 6 two free text passages are shown in the INBOX together with their time of capture. The received and captures free text responses are displayed in the order in which they are received from participants. They can be merged and re-ordered as will be described in more detail hereinafter. To display free text, the administrator can select one or more passages for display on the participant's display 7 or the response devices displays e.g. by highlighting the passages and then selecting the display icon 20c.

The response prompt region 21 enables the administrator to initiate a vote by participants. A start icon 21a starts the vote by displaying the vote options to the participants and enabling the receipt of vote responses. Selection of a stop icon 21b closes the vote to prevent any further vote being accepted. A display icon 21c is provided for selection to display the results of the vote to the participants on the participant's display 7 or the displays of the response devices. As votes are received, these are displayed in the result region 24. This may involve displaying only the final, accumulated result, or displaying votes as they progress in real time.

In this embodiment, a vote can be in initiated by selection of a free text passage from a participant e.g. by dragging the selected text from the text input region 20 into the response prompt region dropping the selection. In this example the question that the participant's are to vote “We need to know everyone's colour preference for the product”. The administrator could initiate a vote simply by outputting this question to require the participants to input text describing their preferred colour. This is a constrained text input which is a structured response. The received responses (votes) can be simply matched by a text matching process to accumulate or aggregate a score for each selection. The matching algorithm can allow for matching of similar votes. For example a simple “yes” or “no” vote, could elicit the responses “yes”, “yep”, “y”, “yeh” which could also be matched to the vote selection of “yes”. In an alternative embodiment, as illustrated in FIG. 6, the administrator can use the interface to input selection options which in this example are 1. Red, 2. Pink, 3. Blue, and 4 Yellow. This enables the participants to simply respond by selecting 1, 2, 3, or 4. It does however require the administrator to reduce the constraints on the responses possible. This may lead to undesirable restrictions on the vote responses by the participants. The approach taken will depend upon the nature of the meeting.

It can hence be seen that the interface allow for unstructured free form inputs from participants to be used to obtain feedback from all participants and to drive the direction of the meeting.

The talk input region 22 is provided to control the capture of audio from participants and to control the audio participation of the participants. A start icon 22a allows the administrator to enable the audio input and capture from a response device of a participant. A stop icon 22b disables the input and capture of the audio input. To select a participant to speak, the administrator can select a passage of text. The data received from the response device identifies the participant (or at least the response device) and this is stored in the database 6. Hence when the administrator considers that a passage of text is interesting and would like to hear from the participant, the text passage can be selected e.g. by highlighting and the start icon 22a selected to enable the input and capture of audio from the participant. The audio from the participant can be played back to all participants over a loud speaker system in a meeting room or the audio can be transmitted to the response devices which can be provided with audio output devices such as loud speakers or headphones. The audio from all speakers, including the administrator can be captured and stored in the database. In this way the database stores a record of the meeting along a time line by storing the text passages, the vote options and responses, and the audio together with any administrator input. This provides a complete record of the meeting and can act as electronic meeting minutes.

The recorded data can be searched and retrieved conventionally by searching for keywords or by searching by time. The complete set of data can be played by with respect to time to play back the record of the meeting.

The display control region 23 includes an icon 23a to clear the participant's display 7. Other display icons can be provided such as icons to control the display on the administrator's interface.

FIGS. 5a to e illustrate a flow diagram of the operation of the system of FIG. 1.

Using the interface illustrated in FIG. 6, the administrator starts a text input session (step S1) by selecting the start icon 20a. Text passage inputs are received (step S2) and displayed in the text input region 20 (step S3). The text inputs are stored in the database indexed by the current session (step S4) to enable retrieval of the text inputs for the session. The text inputs are also stored indexed by time and by participant identifier. Until the administrator closes the text input session by selecting the stop icon 20b (step S5) text inputs continue to be received and are displayed in the text input region 20 in order of the time of receipt. When the administrator selects to stop the input of text (step S5), a process for merging similar texts can be implemented to reduce duplicates. This process can comprise a process initiated by the administrator on the response processor 4, whereby the text is automatically analysed using natural language processing and text responses which are determined to have the same content are merged. The merging can select one text passage to represent the merged text passages or it can concatenate them into one text entry i.e. one selectable passage. The dates of input of the text passages are kept associated with the merged text as are the identities of the participants that input the text. The merging process can also be performed manually by the administrator either of their own volition or under the direction of or with input from participants.

In another embodiment, the text passages can be transmitted to the response devices to enable to participants to suggest merging text passages that they consider similar. They can do this by marking the text passages using the inputs devices on their response devices. The data is fed back to the response processor 4 for processing. This may require a form of contention analysis where participants input to merge different text massages. This contention can simply be highlighted on the administrator interface to enable the administrator to overrule or seek agreement from the participants verbally.

In one embodiment, in order to reduce the input of text by the participants and in order to also reduce the number of duplicate inputs that require merging, the text passages can be transmitted to each response device as they are received by the response processor (response administration device). Hence as a participant goes to enter a text response, if they can see a text passage displayed that represents the point they wish to make, they can simply select the displayed passage using the input device on the response processor to mark the text passages as voted for or seconded. This input selection is transmitted as data to the response processor where the ‘votes’ can be processed and aggregated and retransmitted as updates for display at each response device. In this was each participant is able to see ‘real time’ inputs by other participants.

The administrator then has several options. They can select a text passage to be used as the basis for a vote (step S7), they can select a text passage as the basis for a new session (step S15), they can select a text passage to enable a participant to speak (step S23), they can select to rank or order the text passages (step S30), they can select to display text passages (step S37), they can select to close a session and store it (step S40), or they can select a new session (step S43).

If the administrator selects a text passage for a vote (step S7), the free text passage that is selected e.g. by dragging and dropping, is displayed in the response prompt region 21 of the administrator's interface and the administrator can input vote options such a 1, 2, 3, 4 shown in FIG. 6 (step S8 and S9). Alternatively the administrator can elect to allow a structured response in the form of constrained text. The text is constrained because the question is a closed question with limited valid response options.

The vote question and any options displayed (step S10) on the administrator's display 3 and the administrator selects the start icon 21a to start the vote. Vote responses are received (step S11) and processed (step S12). The processing aggregates the responses to show the number of votes for certain vote options. Alternatively the aggregation can take the form of normalising the votes to provide a fractional or percentage outcome e.g. 60% votes yes and 40% votes no. The results of the vote are displayed in the result region 24 on the administrator's display 3 and the administrator can select the display icon 21c to select to display the voting results on the participant's display 7 or the displays of the response devices. The vote results are stored (step S14) as raw vote inputs which can identify which participant voted in what way and as processed vote data. The process then returns to step S7 to await the next administrator selection.

If the administrator selects a text passage as a new session topic (step S15), the administrator selects to clear the inputs on the interface (step S16), and the start icon 20a is selected to start the capture of text passages from participants (step S17). Text inputs are received from participants (step S18), displayed in the text input region 20 (step S19), and stored in the database for the session (step S20). This continues until the administrator selects the stop icon 20b to close the session (step S21). A process to merge the duplicate text passages can then be undertaken as discussed with regard to step S6. The process then returns to step S7 to await the next administrator selection.

If the administrator selects a text passage to enable a participant to speak (step S23), the participant is identified from the identifier associated with the selected text passage (step S24). A control enable command is then transmitted to the response device of the identified participant (step S25). At the response device the command enables the microphone or opens a communication channel for the audio. Audio is hence received from the response device (step S27). In addition to it being broadcast to the participants via a loudspeaker system or by transmission to their response devices, it is also stored in the database 6 indexed by the session, the time, and the participant (step S27). This continues until the administrator selects the stop icon 22b to disable the audio (step S28), whereupon an audio disable command is transmitted to the response device (step S29) and the process then returns to step S7 to await the next administrator selection.

If the administrator selects to rank or order the text passages (step S30), the text passages are transmitted to the participant response devices (step S31) where they are displayed in the order that they were received by the response processor 4 (step S32). Using the input device 12 on the response device 4, each participant can enter data indicating an order or ranking of the text passages (step S33). They can also add indicators to text passages to indicate that they would like clarification of the point raised in the text, or that they would like to discuss the point. The data is transmitted to the response processor (step S34) and it is processed in order to determine an overall ranking or ordering for the text passages (step S35). The administrator can also allow discussion on certain points if flagged by participants and the administrator can add text to the text passage to clarify points.

If the administrator selects to display the text to the participants (step S37), the administrator selects the text passages to be displayed (step S38) and they are displayed on the participant's displays 7 or transmitted to the response devices for display (step S39).

If the administrator selects a stored session for further discussion (step S40), text passages for the stored session are retrieved from the database 6 (step S41) and displayed on the administrators display 3 (step S42). This enables the subject of a text passage in an earlier session to be revisited for discussion.

If the administrator selects a new session (step S43), the administrator's display is cleared (step S44) to enable the capture of data for the new session. The process then returns to step S1.

As can be seen from the discussion above the initial session can give rise to daughter sessions. The initial session acts as an agenda. One of the text passages is chosen as an agenda item for discussion in the next session. One of the text passages in this daughter session can itself act as an agenda item for discussion in a grand daughter session and so on. This forms a hierarchy of sessions based on text passages as topics or agenda items. Any text passage of any session can be retrieved and selected to act as a new session for discussion and capture of data.

Each session captures not only the text passages which can be used for daughter sessions, but also structures responses in the form of votes on issues, and recordings of audio from participants.

It can be seen from the description of the embodiments given herein above that the embodiments of the present invention provide a system and method which facilitate efficient participation in meetings or events. Embodiments can provide an environment to allow for a flexible free form meeting and a system which follows and captures the flow of the meeting, allowing participants to steer the direction of the discussions, while allowing the capturing of decisions e.g. by recordal of votes.

Although in the embodiments described above, the control and capture of audio is described, the present invention encompasses the control and capture of video from participants. In such an arrangement, the response devices include a video capture device in place of the audio input device 15. The administrator can control the capture of video in the same manner and it can be stored in the database 6 in the same time dependent manner to searching and retrieval.

Embodiments of the present invention can be used for meetings or events taking place in one room, multiple locations, or even a virtual meeting where participants are connected over a network by computers and audio or video is transmitted between the computers.

Although the present invention has been described with reference to specific embodiments, the present invention is not limited to these embodiments and it will be apparent to a skilled person in the art that modifications lie within the spirit and scope of the present invention.

1-17. (canceled)

18. A participant response method comprising:
receiving responses from response devices operated by participants;
associating the response with an identifier;
displaying the received responses;
in response to selection of one of the received responses, identifying a response device using the identifier and generating a control signal to activate a microphone at and/or an audio channel from the identified response device, thereby, enabling audio input from the identified response device.

19. A participant response method according to claim 18, wherein the responses comprise votes and/or free text.

20. A participant response method according to claim 18, wherein the identifier associated with a response comprises identification information uniquely identifying a response device that transmitted the response, and the identifying comprises receiving a user selection of at least one response and the identification of the at least one response device using the identification information.

21. A participant response method according to claim 18, wherein the identifier associated with a response comprises identification information uniquely identifying a participant, wherein identifying a response device using the identifier comprises identifying a participant from the identification information associated with the selected response and identifying a response device associated with the participant.

22. A participant response method according to claim 18, wherein the control signal further activates a camera at and/or a video channel from the identified response device.

23. A participant response method according to claim 18, wherein audio received from the identified response device is broadcast to the participants via a loudspeaker system or by transmission to the response devices.

24. An apparatus comprising:
a receiver configured to receive responses from response devices operated by participants;
a processor configured to associate the response with an identifier;
a display to display the received responses;
an input to receive a selection of one of the displayed received responses;
a processor to, in response to selection of one of the received responses, identify a response device using the identifier and generate a control signal to activate a microphone at and/or an audio channel from the identified response device, thereby, enabling audio input from the identified response device.

25. The apparatus according to claim 24, wherein the responses comprise votes and/or free text.

26. The apparatus according to claim 24, wherein the identifier associated with a response comprises identification information uniquely identifying a response device that transmitted the response, and the processor comprises means for receiving a selection of at least one response and means for identifying the at least one response device using the identification information.

27. The apparatus according to claim 24, wherein the identifier associated with a response comprises identification information uniquely identifying a participant, wherein the processor identifies a response device using the identifier comprises identifying a participant from the identification information associated with the selected response and identifying a response device associated with the participant.

28. The apparatus according to claim 24, wherein the control signal further activates a camera at and/or a video channel from the identified response device.

29. The apparatus according to claim 24, wherein the system is configured to receive audio from the identified response device and broadcast the received audio to the participants via a loudspeaker system or by transmission to the response devices.

30. A participant response system comprising:
one or more response devices operated by participants; and
an apparatus as claimed in claim 24.

31. A carrier medium carrying computer readable code for controlling a computer to carry out the method of claim 18.
